(19) United States
(12) Patent Application Publication
(10) Pub. No.: US 2004/0180594 A1
(43) Pub. Date: Sep. 16, 2004

(54) Pill-resistant sysnthetic fabric and method of making same

(76) Inventors: Stephen F. Waddell, Easley, SC (US); Ray O. Elrod, Liberty, SC (US); Nathan B. Emery, Spartanburg, SC (US)

Correspondence Address: Sara M. Current, Legal Department, M-459, PO Box 1926, Spartanburg, SC, 29304, US

(21) Appl. No.: 10/385,964

(22) Filed: Mar. 11, 2003

(51) Int. Cl. B32B 3/00; B32B 5/02

(52) U.S. Cl. 442/59

(57) ABSTRACT

A synthetic fiber-containing fabric having aesthetic characteristics similar to those of natural fiber-containing fabrics in combination with superior performance characteristics is described. In addition, a method for making pill-resistant fabrics which contain both nonionic and anionic fibers is described.

### BACKGROUND OF THE INVENTION

Synthetic fibers have been utilized in a variety of textile fabrics as a replacement for natural fibers. While generally being considered to have some advantages over their natural counterparts, such as fiber-to fiber consistency and other engineered properties, the advantages in many cases also come with corresponding disadvantages. For example, while polyester fibers can be produced with high levels of strength, they can come with a corresponding undesirable tendency to pill, particularly in the case of spun yarns of polyester fibers. Conventional methods for improving pill resistance generally involve chemically weakening the fibers, in order that loosened fibers can break away from the fabric rather than form a pill ball. While this can be effective in some applications, care must be taken to achieve a proper balance between the pill resistance and fabric strength.

Another disadvantage typically associated with synthetic fibers such as polyester is that they are hydrophobic. Because of the hydrophobicity, they do not wick moisture, which can make garments made from synthetic fiber-containing fabrics uncomfortable in some environments. Nonetheless, synthetic fiber-containing fabrics have gained acceptance in many markets, including apparel.

One example of an accepted synthetic apparel fabric is a woven fabric designed to substitute for wool. The conventional synthetic wool fabric was made from a special polyester which was provided as tow, then stretch-broken in a conventional manner. The fiber was then spun, woven, napped and sheared. While performing well in many respects, the fabrics did not have optimal moisture transport and soil release characteristics.

### SUMMARY OF THE INVENTION

The fabric of the instant invention achieves the desirable feel of a conventional woven wool or synthetic wool-substitute, while having the additional features of good desirability, soil release, wicking and low pilling. To this end, a fabric is woven from spun yarns synthetic fibers (preferably of anionic and nonionic polyester), treated with an anti-pilling treatment, dyed and treated with soil release and wicking chemistry, and fluid treated to bulk the fabric surface, such as by of a hydraulic napping process.

In addition, a pill resistant fabric containing both nonionic and anionic fibers can be produced by the process of treating the substrate (e.g. fiber blend, yarn or fabric) with a defined amount of sodium sulfate and a caustic or amine. Surprisingly, it has been found that the inclusion of the sodium sulfate enables the caustic or amine treatment to achieve pill resistance of the nonionic polyester fibers without adversely impacting the anionic fiber or other properties of the substrate to any significant extent. Without the inclusion of the salt, the caustic would weaken the anionic fiber to the point of failure, which would result in a fabric that was not sufficiently strong for most uses.

### DETAILED DESCRIPTION

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

The instant invention is directed to a new synthetic fiber-containing fabric having many of the characteristics of wool, but having the advantages of synthetic fibers. In addition, the fabrics have good aesthetic characteristics such as hand, as well as good soil release and moisture transport characteristics. Furthermore, the fabrics have good levels of pill resistance, even when made from a combination of nonionic and anionic polyester fibers.

In one aspect of the invention, fabrics are woven from polyester fiber-containing yarns, then treated to increase their pilling resistance by way of a conventional type caustic or amine treatment. As will be readily appreciated by those of ordinary skill in the art, caustic and amine treatments are used to weaken the polyester fibers, so that loosened fibers can break away rather than stay on the fabric surface and form pill balls. Typically, these chemical treatments weaken the fibers by etching or pitting the fiber surface.

However, it was surprisingly found that when the fabric contained anionic fibers, the anti-pilling treatment was too severe, resulting in fabric that was too weak. Therefore, in a further aspect of the invention, where the fabric contains an anionic polyester fiber component, a quantity of sodium sulfate is provided along with the caustic or amine treatment. Unexpectedly, it has been found that the sodium sulfate serves to protect the anionic component from the severity of the increased alkalinity. However the salt has no effect on the nonionic component, and it is weakened to an extent such that the fabric has good pill resistance and retains sufficient strength. As a result, the fabric that has been chemically treated to reduce pilling has etched and/or pitted nonionic fibers that have been weakened, and anionic fibers that are not substantially etched, pitted, or weakened. In addition, although the examples herein describe woven fabrics, it is noted that the anti-pilling process described herein can be used in connection with blends of nonionic and anionic fibers while in fiber, yarn, or other form, and on fabrics made by methods other than weaving, such as knitting or non-woven manufacturing processes.

Where the fabric is provided as a blend of non-ionic and anionic fibers, it is preferably in a ratio of about 30% nonionic and 70% anionic fibers to about 70% nonionic and 30% anionic fibers, and more preferably at a ratio of about 50% nonionic and 50% anionic fibers. However, other ratios are contemplated within the scope of the invention, including blends including minor quantities of one or more other fiber types.

The fabric can also optionally be dyed and finished in a conventional manner, preferably after the anti-pilling treatment. In addition, one or more moisture transport and/or soil release chemistries can optionally be added to the fabric. The fabric is desirably bulked such as by a high pressure fluid treatment.

The fabric of the invention is preferably made from polyester, and preferably substantially all polyester. Where the fabric is made from substantially all polyester, the polyester is preferably a blend of nonionic and anionic polyester. The fabric can be woven in any desired construction, but is preferably woven in a 2×2 twill construction at a weight designed to achieve a finished weight of about 6.2 to about 7.3 oz/sq yard. However, other fabric constructions and weights are contemplated within the scope of the invention. The fabric warp desirably contains at least some spun yarns in order to get maximal benefit from the fluid treatment process, but they can be of any spun variety, including but not limited to open end spun, ring spun, air jet spun, friction spun, vortex spun, or the like. The filling can be made from spun or filament yarns or a combination thereof. However, other construction may be used, depending on the fluid treatment process used and the aesthetic characteristics described.

The yarns can be of any desired size, and will be selected to achieve the desired fabric weight and properties. Preferably, they are from about 8/1s to 30/1s. Where it is desired to produce a fabric with a heather appearance, the fiber denier should be between 1.2 and 3 and the staple length should be between 1.25 and 3 inches. Where a solid shade or less defined heather appearance are desired, the fiber denier can be even smaller (e.g. as small as about 0.8 dpf.) Where filament yarns are used, they are desirably about 150 to about 600 denier, and they may be single or multi-ply. Preferably, they have an individual fiber denier of about 3 or less.

The fabric is then desirably prepared in a conventional manner, with care being taken to ensure that the fabric is clean, such as by scouring more than one time. The fabric is then treated to reduce its pilling propensity, preferably by the application of caustic or an amine. Examples of an amine anti-pilling treatments are described in commonly-assigned U.S. Pat. No. 6,113,656 to Kimbrell (an aliphatic amine treatment), and commonly-assigned co-pending U.S. patent application Ser. No. 09/943,927 to Kimbrell, filed Aug. 31, 2001 (a branched chain amine treatment). The disclosure of U.S. Pat. No. 6,113,656 and U.S. patent application Ser. No. 09/943,927 are hereby incorporated herein by reference. Where the fabric contains an anionic polyester fiber component, the anti-pilling treatment also desirably includes an amount of sodium sulfate, as it has surprisingly been found that the addition of this sodium sulfate protects the anionic fiber to an extent, thereby enabling a reduction in strength of the nonionic fiber sufficient to achieve good pilling performance without undesirably affecting fabric strength. While it is believed that for most 50% anionic polyester fabrics, at least about 2.5% owf of sodium sulfate will be needed, and more preferably at least about 3%. Other concentrations are contemplated within the scope of the invention, depending, for example, on the type of polyester used, fiber size, fabric construction, type, anti-pilling treatment, and the level of pill resistance and strength desired. For example, where the fabric only contains about 30% anionic fiber, it is believed that 1.5% owf sodium sulfate could be used, whereas a fabric containing about 70% of an anionic fiber component may utilize up to about 4% owf sodium sulfate.

The fabric can then be dyed in a conventional manner using the type of dyes appropriate for the particular fiber or fiber combination used. For example, disperse, basic or a combination of disperse and basic dyes can be used within in the scope of the invention. Additional chemistries such as conventional soil release and wicking chemistries are also desirably added, before, during or after the dye process, in order to improve fabric performance.

The fabric is then desirably processed with a high pressure fluid, such as a hydraulic napping process. Examples of hydraulic napping processes are described in U.S. Pat. Nos. 5,080,952; 5,983,469; 5,983,469; 5,933,931; 5,870,807; 5,806,155; 5,737,813; 5,657,520; 5,632,072; 5,136,761; 4,995,151; 4,967,456 and commonly-assigned co-pending U.S. patent application Ser. No. 09/344,596 for Napped Fabric and Process, filed Jun. 25,1999. The disclosures of each of these references are hereby incorporated by reference. The amount of hydraulic treatment will depend upon the fabric treated as well as the desired amount of effect desired, but will typically be controlled to achieve at least about a 25% increase in fabric thickness. For synthetic wool fabrics of the variety described herein, the high pressure fluid treatment will be performed by treating a first side of the fabric with about 0.107 to 0.197 hp-hr/lb of energy and about 0.038 to 0.058 hp-hr/lb of energy on the opposite surface. Even more preferably, about 0.150 hp-hr/lb of energy is applied to the first surface and about 0.048 hp-hr/lb is applied to the second surface.

### EXAMPLES

### Example A

A fabric was woven in a 2×2 twill weave construction using 13.25 open end spun yarns in both the warp and filling. The yarns were a 50/50 blend of 2.25 dpf nonionic and 2.25 dpf anionic mid-tenacity polyester staple about 2 inches long. The greige fabric was scoured in an open width scouring range to remove size existing from the weaving process. The fabric was then scoured again in a dye jet in a conventional manner to ensure its cleanliness. The fabric was then dyed in a conventional manner with disperse dyes and basic dyes and 0.5% sodium sulfate to achieve a heather appearance. In addition, 2.0% and 1.0% of high molecular weight ethoxylated polyester (Lubril QCX and Lubril F, respectively, available from Eastman Chemical of Kingsport, Tenn.) for soil release and wicking. The fabric was then hydraulically treated with an apparatus of the variety described in commonly-assigned U.S. patent application Ser. No. 09/344,596 to Emery et al. The apparatus was run to treat the fabric with approximately 0.150 hp-hr/lb of energy on the fabric face and 0.048 hp-hr/lb on the fabric back. The thickness of the fabric (measured using a Starrett hand-held thickness gauge model 1015A with ¾″ contacts, applying about 250 g of pressure) changed from 0.024″ before hydraulic processing to 0.027″-0.031″ after hydraulic processing.

The fabric was then treated with a 3% solution of the Lubril QCX, and heat set on a tenter frame to 63 inches. The fabric had a finished construction of about 64 ends per inch and 54 picks per inch, and a weight of about 6.7 oz/sq yard.

### Example B

The fabric was produced in the same manner as Example A, except that prior to dyeing, it was treated in a dye jet with a 2% owf caustic at 266 degrees F for a hold time of 30 minutes, and neutralized with acetic acid in a conventional manner. Following the anti-pilling treatment, the fabric was too weak to continue processing and tore by hand.

### Example C

The fabric was produced in the same manner as Example A, except that prior to dyeing, it was treated in a dye jet with a 2% owf caustic and 3% owf sodium sulfate solution at 266 degrees F for a hold time of 30 minutes, and neutralized with acetic acid in a conventional neutralization operation.

### Example D

Is a commercially available 7 oz. synthetic wool womenswear fabric made from the stretch-broken tow of special polyester that was woven, napped and sheared.

Test Methods:

Pilling—Random Tumble Pilling was tested according to ASTM D-3512-99a at 15, 30 and 90 minutes. The ratings are an average of as received and after 5 washes. The maximum rating is 5.0

| | | | Example | Example |
|---|---|---|---|---|
| Test | Example A | Example B | C | D |
| Random Tumble | 2.5 | N/A | 4.5 | 3.5 |
| Pilling | | | | |
| 15 minutes | | | | |
| Random Tumble | 2.5 | N/A | 4.5 | 4.0 |
| Pilling | | | | |
| 30 minutes | | | | |
| Random Tumble | 3.0 | N/A | 4.5 | 4.0 |
| Pilling | | | | |
| 90 minutes | | | | |
| Tear Strength (lbs) | 7.3 × 8.0 | N/A | 7.5 × 6.7 | 6.5 × 5.5 |
| Warp × fill | | | | |

Kawabata Testing

A variety of characteristics were measured using the Kawabata Evaluation System (“Kawabata System”). The Kawabata System was developed by Dr. Sueo Kawabata, Professor of Polymer Chemistry at Kyoto University in Japan, as a scientific means to measure, in an objective and reproducible way, the “hand” of textile fabrics. This is achieved by measuring basic mechanical properties that have been correlated with aesthetic properties relating to hand (e.g. smoothness, fullness, stiffness, softness, flexibility, and crispness), using a set of four highly specialized measuring devices that were developed specifically for use with the Kawabata System. These devices are as follows:

Kawabata Tensile and Shear Tester (KES FB1)

Kawabata Pure Bending Tester (KES FB2)

Kawabata Compression Tester (KES FB3)

Kawabata Surface Tester (KES FB4)

KES FB1 through 3 are manufactured by the Kato Iron Works Col, Ltd., Div. Of Instrumentation, Kyoto, Japan. KES FB4 (Kawabata Surface Tester) is manufactured by the Kato Tekko Co., Ltd., Div. Of Instrumentation, Kyoto, Japan. In each case, the measurements were performed according to the standard Kawabata Test Procedures, with four 8-inch×8-inch samples of each type of fabric being tested, and the results averaged. Care was taken to avoid folding, wrinkling, stressing, or otherwise handling the samples in a way that would deform the sample. The fabrics were tested in their as-manufactured form (i.e. they had not undergone subsequent launderings.) The die used to cut each sample was aligned with the yarns in the fabric to improve the accuracy of the measurements.

Shear and Tensile Measurements

The testing equipment was set up according to the instructions in the Kawabata manual. The Kawabata shear tester (KES FB1) was allowed to warm up for at least 15 minutes before being calibrated. The tester was set up as follows:

Sensitivity: 2 and X5

Sample width: 20 cm

Shear weight: 195 g

Tensile Rate: 0.2 mm/s

Elongation Sensitivity: 25 mm

The shear test measures the resistive forces when the fabric is given a constant tensile force and is subjected to a shear deformation in the direction perpendicular to the constant tensile force.

Mean Shear Stiffness (G) [gf/(cm-deg)]. Mean shear stiffness was measured in each of the warp and filling directions. A lower value for shear stiffness is indicative of a more supple hand.

Shear Hysteresis at 0.5°, 2.5° and 50°—(2HG05, 2HG25, and 2HG50, respectively) [gf/cm]—A lower value indicates that the fabric recovers more completely from shear deformation. This correlates to a more supple hand.

Residual Shear Angle at 0.5°, 2.5°, and 5.0° (RG05, RG25, and RG50, respectively.) [degrees] The lower the number, the more “return energy” required to return the fabric to its original orientation.

Tensile Energy (WT) was measured in each of the warp and filling directions. A lower tensile energy generally indicates the fabric has “give” to it and is more extensible, which would be expected to be indicative of greater fabric comfort.

Linearity of Extension (LT)—Dimensionless—Indicates consistency of extension.

Tensile Resiliency(RT)—Measured in percent. Indicates ability of fabric to recover from tensile stretch.

Percent Extensibility (EMT)—Measured in each of the warp and filling directions. A higher number indicates a fabric has a greater stretch property. (This is a static profile.)

Four samples were taken in each of the warp and filling directions, averaged for each, and are listed below.

Bending Measurements

Bending Stiffness (B)—_A lower value means a fabric is less stiff. Four samples were taken in each of the warp and filling directions, averaged for each, and are listed below.

Bending hysteresis at 0.5°, 1.0°, and 1.5° (2HB05, 2HB10, 2HB15) Mean bending stiffness per unit width at K=0.5, 1.0 and 1.5 cm⁻¹ [gf-cm/cm]. Bending stiffness was measured in each of the warp and filling. A lower value means the fabric recovers more completely from bending, and has a softer, more supple hand.

Residual Bending at 0.5°, 1.0°, and 1.5°—(RB05, RB10, RB15) Residual bending curvature at K=0.5, 1.0 and 1.5 cm⁻¹. A lower residual bending curvature indicates that a fabric is stiffer (less supple).

Compression Analysis

The testing equipment was set up according to the instructions in the Kawabata manual. The Kawabata Compression Tester (KES FB3) was allowed to warm up for at least 15 minutes before being calibrated. The tester was set up as follows:

Sensitivity: 2 and X5

Stroke: 5 mm

Compression Rate: 1 mm/50 s

Sample Size: 20×20 cm

The compression test measured the resistive forces experienced by a plunger having a certain surface area as it moves alternately toward and away from a fabric sample in a direction perpendicular to the fabric. The test ultimately measures the work done in compressing the fabric (forward direction) to a preset maximum force and the work done while decompressing the fabric (reverse direction).

Percent compressibility at 0.5 grams (COMP05) (%)The higher the measurement, the more compressible the fabric.

Maximum Thickness (TMAX)—Thickness [mm] at maximum pressure (nominal is 50 gf/cm²). A higher TMAX indicates a loftier fabric.

Minimum Thickness (TMIN) Thickness at 0.5 g/sq cm. More is generally considered to be better. A higher TMIN indicates a loftier fabric.

Minimum Density—Density at TMIN (DMIN). Less is generally considered to be better) Tₘᵢₙ[g/cm³]

Maximum Density—Density at TMAX (DMAX)—Tₘₐₓ[g/cm³] A lower value is generally considered to be better.

Compressional Work per Unit Area (WC) Energy to compress fabric to 50 gf/cm²[gf-cm/cm²]. More is generally considered to be better.

Decompressional Work per Unit Area (WC′) This is an indication of the resilience of the fabric. A larger number indicates more resilience (i.e. a springier hand), which is generally considered to be better.

Linearity of Compression—0.5 grams—(LCO5)—Compares compression work with the work along a hypothetical straight line from (X₀, y(X₀)) to (Xₘₐₓ, y(Xₘₐₓ)) The closer to linear, the more consistent the fabric is.

% Compression Resilience—(RC) Higher means recovers better from compression.

Thickness Change During Compression (TDIFF)—Higher indicates a loftier fabric.

Surface Analysis

The testing equipment was set up according to the instructions in the Kawabata Manual. The Kawabata Surface Tester (KES FB4) was allowed to warm up for at least 15 minutes before being calibrated. The tester was set up as follows:

Sensitivity 1: 2 and X5

Sensitivity 2: 2 and X5

Tension Weight: 480 g

Surface Roughness Weight: 10 g

Sample Size: 20×20 cm

The surface test measures frictional properties and geometric roughness properties of the surface of the fabric.

Coefficient of Friction—(MIU) Mean coefficient of friction [dimensionless]. This was tested in each of the warp and filling directions. A higher value indicates that the surface consists of more fiber ends and loops, which gives the fabric a soft, fuzzy hand. Four samples were taken in each of the warp and filling directions, averaged, and are listed below.

Mean Deviation of Coefficient of Friction (MMD)—Indicates the level of consistency of the coefficient of friction.

Surface roughness (SMD) Mean deviation of the displacement of contactor normal to surface [microns]. Indicative of how rough the surface of the fabric is. A lower value indicates that a fabric surface has more fiber ends and loops that give a fabric a softer, more comfortable hand. Four samples were taken in each of the warp and filling directions, and are listed below.

Prior to Kawabata Testing, all of the fabrics were home laundered one time and tumble dried to remove any handbuilders, etc. that may have been on the fabrics. As noted previously, the Example B fabric was too weak to continue processing. The results of the Kawabata Tests are listed in the table below.

| | Example A | | Example C | | Example D | |
|---|---|---|---|---|---|---|
| Parameter | Warp | Fill | Warp | Fill | Warp | Fill |
| B | 0.25 | 0.185 | 0.157 | 0.098 | 1.1375 | 0.1018 |
| 2HB05 | 0.232 | 0.164 | 0.136 | 0.077 | 0.0573 | 0.03925 |
| 2HB10 | 0.294 | 0.209 | 0.168 | 0.092 | 0.0715 | 0.04475 |
| 2HB15 | 0.315 | 0.231 | 0.187 | 0.104 | 0.08375 | 0.05025 |
| RB05 | 0.938 | 0.89 | 0.868 | 0.778 | 0.4155 | 0.3855 |
| RB10 | 1.186 | 1.13 | 1.07 | 0.934 | 0.5208 | 0.443 |
| RB15 | 1.267 | 1.251 | 1.188 | 1.05 | 0.6095 | 0.4963 |
| MIU | 0.242 | 0.235 | 0.22 | 0.225 | 0.254 | 0.26 |
| MMD | 0.026 | 0.024 | 0.029 | 0.027 | 0.026 | 0.027 |
| SMD | 5.707 | 5.763 | 5.809 | 5.981 | 5.1623 | 5.5303 |
| WT | 5.561 | 8.552 | 6.996 | 8.519 | 5.6335 | 6.4445 |
| LT | 0.648 | 0.687 | 0.624 | 0.608 | 0.5945 | 0.6605 |
| RT | 54.547 | 51.052 | 56.124 | 52.86 | 60.3395 | 57.5723 |
| EMT | 3.394 | 4.898 | 4.424 | 5.525 | 3.7288 | 3.8375 |
| COMP05 | 44.809 | — | 41.478 | — | 47.28 | — |
| DMIN | 0.188 | — | 0.219 | — | 0.2005 | — |
| DMAX | 0.34 | — | 0.374 | — | 0.3798 | — |
| LC05 | 0.398 | — | 0.354 | — | 0.3125 | — |
| RC | 54.897 | — | 53.481 | — | 48.651 | — |
| TMIN | 1.196 | — | 1.029 | — | 1.168 | — |
| TDIFF | 0.536 | — | 0.427 | — | 0.5545 | — |
| TMAX | 0.659 | — | 0.602 | — | 0.6138 | — |
| WC | 0.532 | — | 0.377 | — | 0.4328 | — |
| WC′ | 0.292 | — | 0.201 | — | 0.21 | — |
| WEIGHT | 22.435 | — | 22.525 | — | 23.3 | — |
| (g/m²) | | | | | | |
| G | 0.914 | 0.819 | 0.671 | 0.662 | 0.654 | 0.6 |
| 2HG05 | 0.68 | 0.65 | 0.773 | 0.742 | 0.845 | 0.706 |
| 2HG25 | 1.686 | 1.543 | 1.424 | 1.41 | 1.4343 | 1.2908 |
| 2HG50 | 3.178 | 3.004 | 2.541 | 2.568 | 2.6265 | 2.5445 |
| RG05 | 0.745 | 0.795 | 1.154 | 1.125 | 1.2945 | 1.1788 |
| RG25 | 1.844 | 1.884 | 2.124 | 2.132 | 2.1935 | 2.154 |
| RG50 | 3.475 | 3.671 | 3.791 | 3.881 | 4.0143 | 4.2428 |

In another alternative embodiment of the invention, anionic polyester fibers or yarns can be treated with the pill reducing chemistry prior to being formed into fabric. For example, they can be treated with sodium sulfate and the caustic or amine in a package dye apparatus.

The fabrics of the invention can be used in any desired end use, including but not limited to apparel, home furnishings, upholstery, automotive, napery, etc.

In the specification there has been set forth a preferred embodiment of the invention, and although specific terms are employed, they are used in a generic and descriptive sense only and not for purposes of limitation, the scope of the invention being defined in the claims.

1. A method of decreasing the pilling propensity of a fabric comprising a blend of anionic and nonionic polyester fibers comprising the step of:
treating the fabric with a chemical treatment comprising (a) ≧about 1.5% owf sodium sulfate and (b) ≧about 2% owf caustic or an amine.

2. The method according to claim 1, wherein said fabric contains staple fibers of anionic polyester.

3. The method according to claim 1, wherein said fabric contains filament fibers of anionic polyester.

4. The method according to claim 1, wherein said fabric comprises anionic polyester and nonionic polyester.

5. The method according to claim 1, wherein said step of treating is performed by contacting the fabric with a bath having a temperature of about 266 F for at least about 30 minutes.

6. The method according to claim 1, wherein said fabric has at least about 30% anionic polyester fibers.

7. The method according to claim 1, wherein said fabric has at least about 50% anionic fibers.

8. The method according to claim 7, wherein said chemical treatment comprises about 2% or greater of sodium sulfate.

9. The method according to 7, wherein said chemical treatment comprises about 2.5% or greater of sodium sulfate.

10. A fabric produced according to the method of claim 1.

11. A blend of nonionic and anionic polyester fibers comprising a chemical treatment of ≧1.5% owf sodium sulfate and at least one of a caustic and an amine.

12. The blend according to claim 11, wherein said blend comprises at least about 30% anionic polyester fibers.

13. The blend according to claim 11, wherein said blend comprises at least about 50% anionic polyester fibers and about 2% owf or greater of sodium sulfate.

14. The blend according to claim 13, wherein said blend comprises about 2.5% owf or greater of sodium sulfate.

15. A woven fabric having a weight of less than about 8 oz/sq yd, said fabric comprising comprised of 50% anionic and 50% nonionic fibers with a tear strength greater than 6.5 lbs in both warp and fill directions and pilling ratings of at least about 4.5 out of 5.0 at 15 minutes.

16. The fabric according to claim 15, wherein said fabric has a pilling rating of at least about 4.5 after 30 minutes.

17. The fabric according to claim 15, wherein said fabric has a pilling rating of at least about 4.5 after 90 minutes.

18. The fabric according to claim 15, wherein said fabric consists essentially of polyester.

19. A fabric made from a blend of anionic and nonionic polyester fibers, wherein said fabric has been chemically treated such that the nonionic polyester fibers are weakened and the anionic polyester fibers are not substantially weakened.

20. A fabric made from a blend of anionic and nonionic polyester fibers, wherein the nonionic polyester fibers comprise a plurality of surface etches or pits and the anionic polyester fibers are substantially free from surface etches or pits.

21. A method of decreasing the pilling propensity of a polyester-fiber containing fabric comprising:
providing a fabric having a blend of nonionic and anionic polyester fibers, and
chemically weakening the nonionic polyester fibers without substantially weakening the anionic polyester fibers, to thereby provide a fabric having good strength and pill resistance.

22. The method according to claim 21, further comprising the step of dyeing one of the nonionic or anionic polyester fiber components to a visual shade distinct from that of the other component, to thereby achieve a heather fabric appearance.
